(19) United States
(12) Patent Application Publication
(10) Pub. No.: US 2026/0204262 A1
(43) Pub. Date: Jul. 16, 2026

(54) GROUP VOICE-RECOGNIZED AGGREGATED TRANSCRIBE AND PERSONALIZATION

(71) Applicant: Dell Products L.P., Round Rock, TX (US)

(72) Inventors: Michael John Morton, Morrisville, NC (US); Richard A Backhouse, Apex, NC (US); David Joseph Zavelson, Austin, TX (US); Robert C Hernandez, Morrisville, NC (US); Erik Summa, Lockhart, TX (US)

(21) Appl. No.: 19/024,013

(22) Filed: Jan. 16, 2025

(51) Int. Cl. G10L 17/02; G10L 25/78

(52) U.S. Cl. CPC G10L 17/02; G10L 25/78

(57) ABSTRACT

Described is technology that facilitates conversation analysis using voiceprint identification. For instance, operations can be performed, comprising, based on sensed signals corresponding to a conversation, wherein the sensed signals at least partially correspond to voice soundwaves comprised in the conversation, recording the sensed signals as signal data. Operations can further comprise analyzing the signal data based on classification data representative of at least one specification determined to be applicable to the conversation and, based on the analyzing, mapping the signal data to an origination source representative of an origin of the sensed signals.

### BACKGROUND

Recording of a conversation, such as a meeting, is often performed by a microphone external to a participant's computing device, or through a network-based application and results in an audio file comprising lack of useful metadata to a participant or other user entity.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. Its sole purpose is to present one or more concepts of the disclosure in a streamlined form as a prelude to the more detailed description that is presented later.

Described herein are one or more frameworks directed to conversation analysis using voiceprint identification, which can, optionally, employ an analytical model, such as an artificial intelligence model, neural network model, machine learning model, language model, and/or the like.

An example system can comprise at least one processor, and at least one memory that stores executable instructions that, when executed by the at least one processor, facilitates performance of operations, comprising: based on sensed signals corresponding to a conversation, wherein the sensed signals at least partially correspond to voice soundwaves comprised in the conversation, recording the sensed signals as signal data, analyzing the signal data based on classification data representative of at least one specification determined to be applicable to the conversation, and, based on the analyzing, mapping the signal data to an origination source representative of an origin of the sensed signals.

An example method, such as a computer-implemented method, can comprise identifying, by a system comprising at least one processor, recorded signal data corresponding to voice soundwaves of a conversation, assigning, by the system, respective origination sources corresponding to the voice soundwaves, and generating, by the system, environmental map data comprising location data representative of respective locations of the respective origination sources relative to one another.

An example method, such as a computer-implemented method, can comprise detecting, by a computing device comprising at least one processor, voice soundwaves of a conversation, using a sensor at an external surface of the computing device, recording, by the computing device, signal data based on the voice soundwaves, using a microphone at the external surface or another external surface of the computing device, and in response to the recording, generating, by the computing device, a notification that the recording has begun or is in progress.

An example benefit of one or more of the above-indicated methods and/or systems can be an ability to provide secondary data, such as metadata, corresponding to a recorded conversation and allowing for responding to queries to a system regarding the recorded conversation. That is, based on analysis of the recorded conversation, hardware specifications of recording devices, classification data comprising conversation specifications, etc., one or more voiceprints, origination sources, correspondences of voiceprints to origination locations, locations of origination sources relative to one another, correspondences of one or more spoken words to one or more voiceprints, etc., one or more queries and/or responses can be facilitated.

Another example benefit of one or more of the above-indicated methods and/or systems can be an ability to provide the analysis and query response processes based on multiple recordings from different vantages (e.g., locations in a single environment, participant computing devices, network-based recordings, environments, time ranges, etc.).

Yet another example benefit of one or more of the above-indicated methods and/or systems can be an ability to provide information collection, collation, and/or storage corresponding to at least voice soundwaves that have been recorded from a conversation and/or tagged based on classification data defining the conversation. Such classification data can comprise meeting time, meeting location, meeting software and/or other medium, participants, etc. Information collation can comprise, but is not limited to, associating of information among multiple conversations. Further, such information collection, collation and/or storage can be performed for multiple recordings of a same conversation, such as from different vantages.

Still another example benefit of one or more of the above-indicated methods and/or systems can be an ability to provide triggering of starting and/or stopping of recording of a conversation at a computing device based on voiceprint recognition corresponding to classification data for the conversation, based on movement of the computing device at a location corresponding to the classification data, and/or based on the computing device entering a dormant state at a location corresponding to the classification data.

As used herein, a dormant state can refer to a deactivated state, such as of a keyboard, screen, etc. and/or a sleep state, such as of an operating system, of a recording device 256. It is noted that one or more processes still can be operating, such as by and/or directed by a processor, while a keyboard, screen, etc. is not in use and the computing device is in a corresponding dormant state. Additionally, and/or alternatively, a dormant state can correspond to closing of a laptop clamshell/lid, placing of a tablet or phone in a particular position (e.g., face down), etc.

### BRIEF DESCRIPTION OF THE DRAWINGS

The technology described herein is illustrated by way of example and not limited to the accompanying figures in which like reference numerals indicate similar elements.

FIG. 1 illustrates a block diagram of an example, non-limiting system that can provide conversation analysis, in accordance with one or more example embodiments described herein.

FIG. 2 illustrates a block diagram of another example, non-limiting system that can provide conversation analysis, in accordance with one or more example embodiments described herein.

FIG. 3 illustrates a schematic diagram of an example environments layout in which recording can be executed by the non-limiting system of FIG. 2, in accordance with one or more example embodiments described herein.

FIG. 4 illustrates a schematic diagram of an example data recording and analysis flow that can be executed by the non-limiting system of FIG. 2, in accordance with one or more example embodiments described herein.

FIG. 5 illustrates an example list of classification data that can be employed by the non-limiting system of FIG. 2, in accordance with one or more example embodiments and/or implementations described herein.

FIG. 6 illustrates an example data storage flow diagram that can be employed by the non-limiting system of FIG. 2, in accordance with one or more example embodiments and/or implementations described herein.

FIG. 7 illustrates a schematic diagram of an example alternative root node that can be employed with the example data storage flow processes of FIG. 6, by the non-limiting system of FIG. 2, in accordance with one or more example embodiments and/or implementations described herein.

FIG. 8 illustrates a process flow diagram of an example method of conversation analysis that can be performed by the non-limiting system of FIG. 2, in accordance with one or more example embodiments and/or implementations described herein.

FIG. 9 illustrates a continuation of the process flow diagram of the example method of conversation analysis of FIG. 8, in accordance with one or more example embodiments and/or implementations described herein.

FIG. 10 illustrates a process flow diagram of another example method of conversation analysis that can be performed by the non-limiting system of FIG. 2, in accordance with one or more example embodiments and/or implementations described herein.

FIG. 11 illustrates a continuation of the process flow diagram of the example method of conversation analysis of FIG. 10, in accordance with one or more example embodiments and/or implementations described herein.

FIG. 12 illustrates a block diagram of an example operating environment into which embodiments of the subject matter described herein can be incorporated.

FIG. 13 illustrates an example schematic block diagram of a computing environment with which the subject matter described herein can interact and/or be implemented at least in part.

### DETAILED DESCRIPTION

### OVERVIEW

The technology described herein is generally directed towards systems, methods and/or computer program products for facilitating conversation analysis using an analytical model, resulting in ability to store metadata related to conversation information and to employ that metadata for responding to queries to the analytical model.

As used herein, an analytical model can comprise an artificial intelligence model, neural network model, machine learning model, language model, and/or the like, such as employing one or more layers of neurons to store and access data using one or more algorithms and/or specified parameters. This can provide for a set of rules and calculations that process data to make predictions based on patterns learned, by the analytical model from a training process employing training data.

Generally, in existing frameworks, a microphone or other software, firmware and/or hardware aspect records audio soundwaves, such as voice soundwaves, allowing for recording of a conversation. For example, a microphone device in a conference room can record soundwaves using a computing device comprising a memory operatively coupled to a processor. Alternatively, a network-based software and/or firmware can record the audio soundwaves received from multiple origination sources connected to one another (e.g., streaming) via a network, whether local, web-based, etc.

The resulting recording can comprise conversation data and/or metadata that can be re-played in video and/or audio form. In one or more cases, a transcript can be generated based on the conversation data (which can comprise metadata). However, additional information allowing for queries and responses corresponding to the conversation data simply are not enabled. Furthermore, correspondences between conversation data for one conversation and second conversation data for a second conversation are not provided for.

As a result, obtaining insights and information from such conversation data is only possible through manual processes (e.g., listening, note taking, reading transcripts, etc.). That is, recordings of conversations made using existing frameworks are often used only as backup, such as in case a discussion point is forgotten. The existing frameworks do not allow for generating of additional useful data related to any of voiceprints, origination source, correspondences between participants, correspondences between conversations, aggregation of conversation data form multiple recording sources, use of conversation data by an analytical model to respond to queries regarding one or more conversations, etc.

To make up for one or more of these deficiencies, one or more example frameworks described herein can be implemented as a plug-and-play process, without being limited by structure, software, hardware, firmware, etc., to provide for generating of additional useful data related to any of voiceprints, origination source, correspondences between participants, correspondences between conversations, aggregation of conversation data form multiple recording sources, use of conversation data by an analytical model to respond to queries regarding one or more conversations, etc.

Indeed, the one or more frameworks described herein can be employed to analyze conversation data recorded from a conversation and provide outputs further defining various aspects of the conversation (e.g., information discussed, environments of the conversation, participants of the conversation, etc.). For example, based on analysis of the recorded conversation, hardware specifications of recording devices, classification data comprising conversation specifications, etc., one or more voiceprints, origination sources, correspondences of voiceprints to origination locations, locations of origination sources relative to one another, correspondences of one or more spoken words to one or more voiceprints, etc. one or more queries and/or responses can be facilitated.

In one or more embodiments, one or more frameworks described herein can provide the analysis and query response processes based on multiple recordings from different vantages (e.g., locations in a single environment, participant computing devices, network-based recordings, environments, time ranges, etc.).

In one or more embodiments, one or more frameworks described herein can provide information collection, collation, and/or storage corresponding to at least voice soundwaves recorded from a conversation and/or classification data defining the conversation. Such classification data can comprise meeting time, meeting location, meeting software and/or other medium, participants, etc. Information collation can comprise, but is not limited to, associating of information among multiple conversations. Further, such information collection, collation and/or storage can be performed for multiple recordings of a same conversation, such as from different vantages.

In one or more embodiments, one or more frameworks described herein can provide triggering of starting and/or stopping of recording of a conversation at a computing device based on voiceprint recognition corresponding to classification data for the conversation, based on movement of the computing device at a location corresponding to the classification data, and/or based on the computing device entering a dormant state at a location corresponding to the classification data.

### TERMINOLOGY

As used herein, the terms “cost” or “expense” can refer to power, memory and/or processing power.

As used herein, the term “data” can comprise “metadata.”

Reference throughout this specification to “embodiment,” “one embodiment,” “an embodiment,” “one implementation,” and/or “an implementation,” means that a feature, structure, or characteristic described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the features, structures, or characteristics may be combined in any suitable manner in one or more embodiments/implementations.

As used herein, the terms “employing” or “employed by” can refer to an element (e.g., a hardware device) that is currently being employed, that has already been employed and/or that is to be employed.

As used herein, the term “entity” can refer to a machine, device, smart device, component, hardware, software and/or human.

As used herein, the term “group” can refer to one or more.

As used herein, with respect to any aforementioned and below mentioned uses, the term “in response to” can refer to any one or more states including, but not limited to: at the same time as, at least partially in parallel with, at least partially subsequent to and/or fully subsequent to, where suitable.

As used herein, the term “power” can refer to electrical and/or other source of power available to the operation system.

As used herein, the term “resource” can refer to power, money, memory, CPU, NPU, GPU, bandwidth, processing power, labor, hardware and/or software.

As used herein, the term “set” can refer to one or more.

### EXAMPLE ARCHITECTURES

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident, however, in various cases, that the one or more embodiments can be practiced without these specific details.

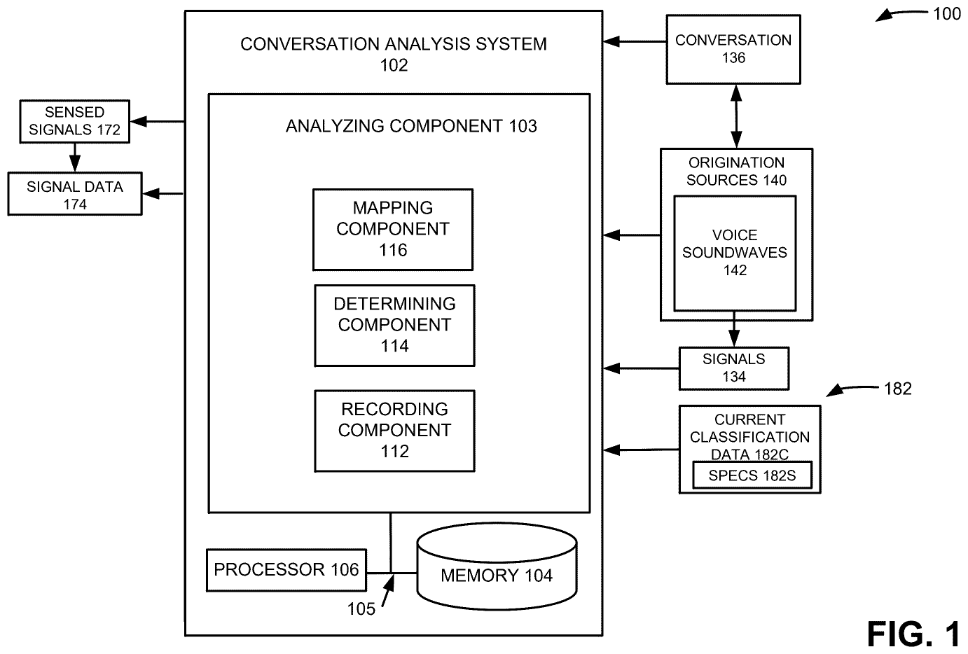

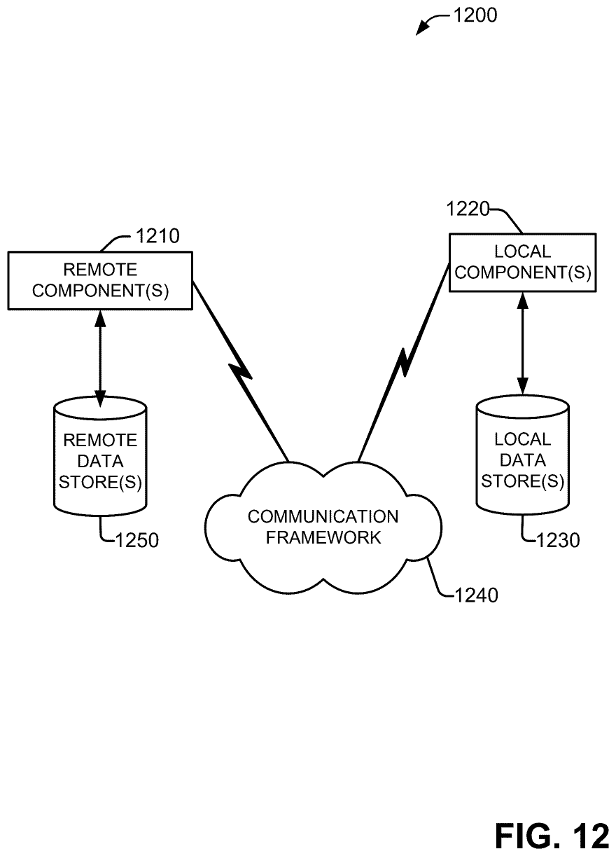

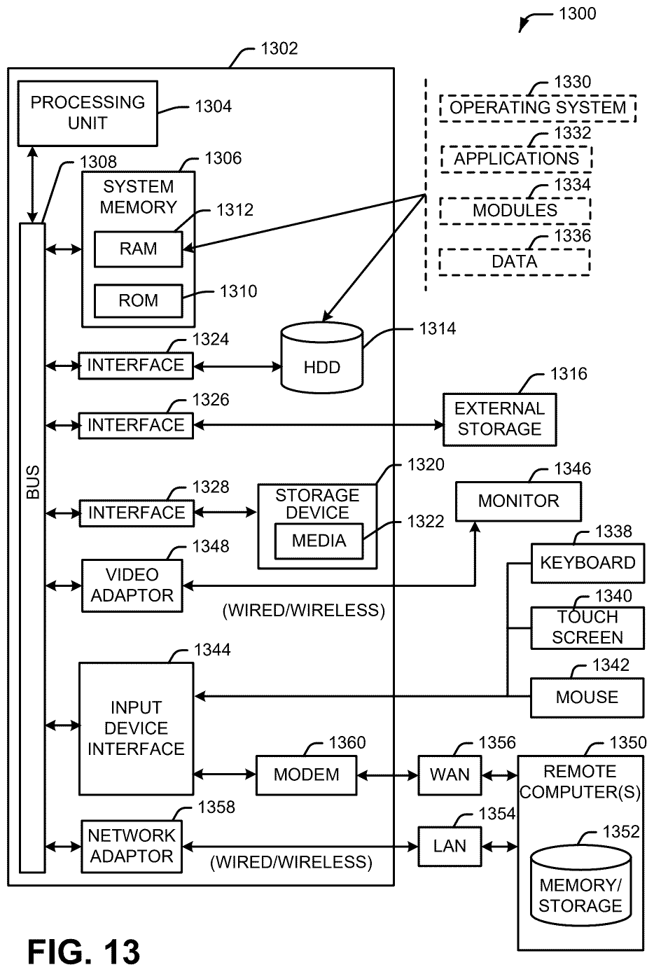

Further, the embodiments depicted in one or more figures described herein are for illustration only, and as such, the architecture of embodiments is not limited to the systems, devices and/or components depicted therein, nor to any order, connection and/or coupling of systems, devices and/or components depicted therein. For example, in one or more embodiments, the non-limiting system architectures described, and/or systems thereof, can further comprise one or more computer and/or computing-based elements described herein with reference to an operating environment, such as the operating environment 1200 illustrated at FIG. 12. In one or more described embodiments, computer and/or computing-based elements can be used in connection with implementing one or more of the systems, devices, components and/or computer-implemented operations shown and/or described in connection with FIGS. 1-11 and/or with other figures described herein, such as from the computing environment 1300 illustrated at FIG. 13.

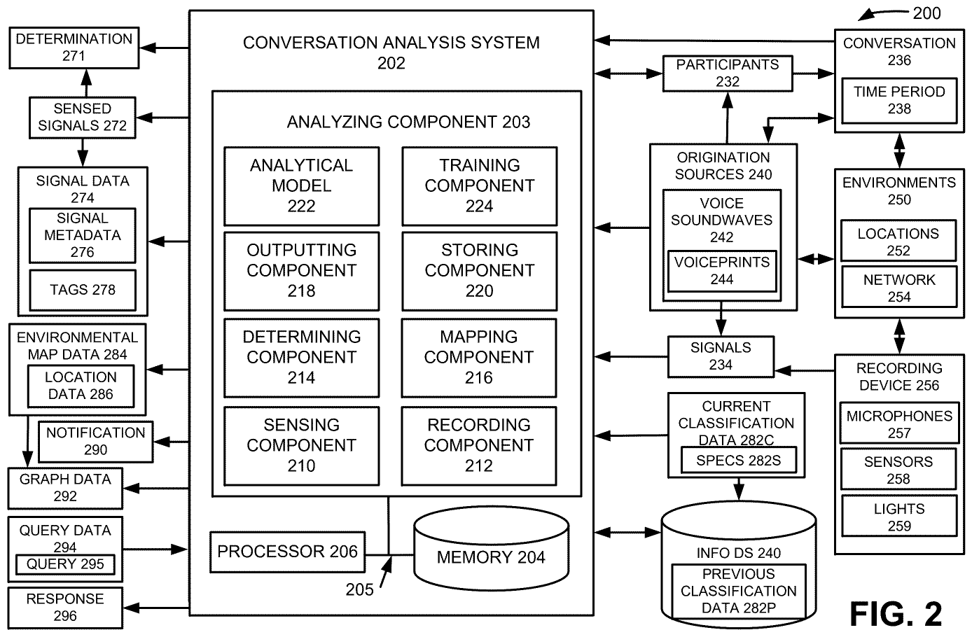

Turning now in particular to one or more figures, and first to FIG. 1, illustrated is a non-limiting system 100 comprising a conversation analysis system 102 that can perform recording, analyzing and query responding relative to a conversation (e.g., conversation 136) among participants. It is noted that the conversation analysis system 102 is only briefly described relative to FIG. 1 to provide but a lead-in to description of a more complex and/or more expansive conversation analysis system 202 as illustrated at FIG. 2. Further detail regarding processes that can be performed by one or more embodiments described herein will be provided below relative to the non-limiting system 200 of FIG. 2.

Still referring to FIG. 1, the conversation analysis system 102 can comprise at least a memory 104, bus 105, processor 106, recording component 112, determining component 114 and/or mapping component 116. Using these components and using one or more inputs to the conversation analysis system 102 (e.g., classification data 182) the conversation analysis synthesis system 102 can provide for analysis and output defining various aspects of the conversation 136, beyond mere recording of audio/video and subsequent text dialogue transcription, as are the limits of existing frameworks.

Generally, the recording component 112 can, based on sensed signals 172 corresponding to a conversation 136, where the sensed signals 172 at least partially correspond to voice soundwaves 142 comprised in the conversation, record the sensed signals 172 as signal data 172. It will be appreciated that the signals 134 themselves can be sensed by the conversation analysis system 102 and/or by a recording device communicatively coupled to the conversation analysis system 102, such as where the signals 134 are transmitted to the conversation analysis system 102 for the recording. The recording can be stored to the memory 104 and/or to a datastore comprised by and/or separate from the conversation analysis system 102. The signal data 174 can be stored in any suitable format.

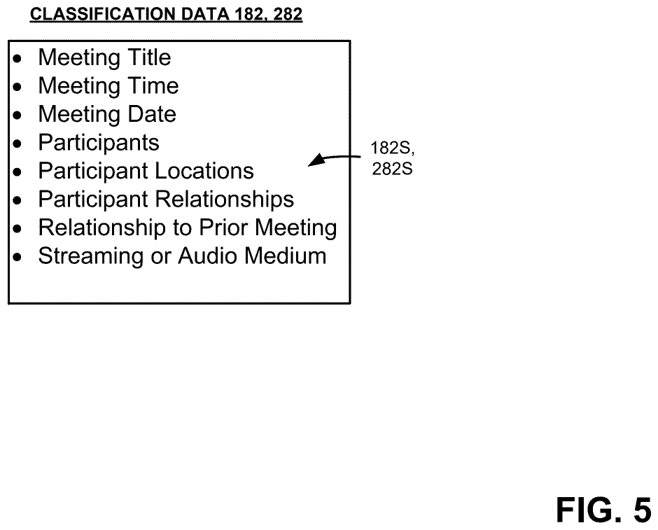

The determining component 114 can analyze the signal data 174 based on classification data 182, 182C representative of at least one specification 182S determined to be applicable to the conversation 136. That is, the classification data 182, such as current classification data 182 that is applicable to the conversation 136, can be obtained by the determining component 114 and/or any other aspect of the conversation analysis system 102. Looking briefly to FIG. 5, the classification data 182 can comprise any one or more specifications 182C comprising a meeting (e.g., conversation) title, meeting time, meeting date, participants, participant locations, participant relationships, relationship to a prior meeting and/or streaming and/or audio medium specification. The classification data 182/specifications 182S can comprise data and/or metadata in any suitable format.

The mapping component can generally, based on the analyzing, map the signal data 174 to an origination source 140 representative of an origin of the sensed signals 172. That is, one or more origination sources 140 can be the one or more respective origins for voice soundwaves 142/signals 134 detected as the sensed signals 172. The origination source 140 can be a participant entity, for example, to the conversation 136.

Accordingly, in summary, the conversation analysis system 102 can provide for generating of metadata (e.g., mapping metadata) providing for an origination source 140 of the voice soundwaves 142, thus providing more than mere recording of a conversations 136 and mere associated transcription. It will be appreciated that the analyzing and/or mapping can be at least partially facilitated by an analytical model, as will be discussed below in greater detail relative to FIG. 2.

In one or more embodiments, the recording component 112, determining component 114 and/or mapping component 116 can be implemented independently, without the other of the recording component 112, determining component 114 and/or mapping component 116. Additionally and/or alternatively, the recording component 112, determining component 114 and/or mapping component 116 can be comprised by an analyzing component 103, the analyzing component 103 can perform one or more of the above-described functions of the recording component 112, determining component 114 and/or mapping component 116, and/or the recording component 112, determining component 114 and/or mapping component 116 can be omitted with the analyzing component 103 performing one or more of the above-described functions of the omitted recording component 112, determining component 114 and/or mapping component 116.

In general, the non-limiting system 100 can employ any suitable method of communication (e.g., electronic, communicative, internet, infrared, fiber, etc.) to provide communication between the classical system 102 and any one or more recording devices 256, for example.

Turning next to FIG. 2, a non-limiting system 200 is illustrated that can comprise a conversation analysis system 202. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

Generally, the non-limiting system 200 can facilitate processes for recording, analyzing and query responding relative to a conversation (e.g., conversation 236) among participants (e.g., participants 232).

Turning first to the conversation analysis system 202, one or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2(3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The conversation analysis system 202 can be associated with, such as accessible via, a cloud computing environment.

The conversation analysis system 202 can comprise a plurality of components. The components can comprise a memory 204, processor 206, bus 205, sensing component 210, recording component 212, determining component 214, mapping component 216, outputting component 218, storing component 220, analytical model 222 and/or training component 224. Using these components, and optionally using one or more inputs, such as from an information datastore 240, the non-limiting system 200 generally can provide for provision of various outputs related to a conversation 236, such as, but not limited to, automatic recording, notification 290 of recording, responses 296 to queries regarding the subject matter or specifications related to the conversation 236, participant entity identities, conversation location 252, locations of participants relative to one another, relationships between participants, and/or relationships between the conversation 236 and one or more prior conversations. Thus, in summary, the conversation analysis system 202, as will be described below in detail, can provide for provision of various aspects of information and/or insights, well beyond that able to be provided by existing conversation recording and analyzing frameworks.

Discussion first turns briefly to the processor 206, memory 204 and bus 205 of the conversation analysis system 202. For example, in one or more embodiments, the conversation analysis system 202 can comprise the processor 206 (e.g., computer processing unit, microprocessor, classical processor, quantum processor and/or like processor). In one or more embodiments, a component associated with conversation analysis system 202, as described herein with or without reference to the one or more figures of the one or more embodiments, can comprise one or more computer and/or machine readable, writable, and/or executable components and/or instructions that can be executed by processor 206 to provide performance of one or more processes defined by such component and/or instruction. In one or more embodiments, the processor 206 can comprise the sensing component 210, recording component 212, determining component 214, mapping component 216, outputting component 218, storing component 220, analytical model 222 and/or training component 224.

In one or more embodiments, the conversation analysis system 202 can comprise the computer-readable memory 204 that can be operably connected to the processor 206. The memory 204 can store computer-executable instructions that, upon execution by the processor 206, can cause the processor 206 and/or one or more other components of the conversation analysis system 202 (e.g., sensing component 210, recording component 212, determining component 214, mapping component 216, outputting component 218, storing component 220, analytical model 222 and/or training component 224) to perform one or more actions. In one or more embodiments, the memory 204 can store computer-executable components (e.g., sensing component 210, recording component 212, determining component 214, mapping component 216, outputting component 218, storing component 220, analytical model 222 and/or training component 224).

The conversation analysis system 202 and/or a component thereof as described herein, can be communicatively, electrically, operatively, optically, and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more embodiments, the conversation analysis system 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the conversation analysis system 202 and/or of the non-limiting system 200 can reside in the cloud, and/or can reside locally in a local computing environment (e.g., at a specified location).

In general, the non-limiting system 200 can employ any suitable method of communication (e.g., electronic, communicative, internet, infrared, fiber, etc.) to provide communication between the conversation analysis system 202 and anyone or more recording devices 256, information datastores 240, and/or other computing devices.

In addition to the processor 206 and/or memory 204 described above, the conversation analysis system 202 can comprise one or more computer and/or machine readable, writable and/or executable components and/or instructions that, when executed by processor 206, can provide performance of one or more operations defined by such component and/or instruction.

Discussion next turns to the additional components of the conversation analysis system 202 (e.g., sensing component 210, recording component 212, determining component 214, mapping component 216, outputting component 218, storing component 220, analytical model 222 and/or training component 224).

First, it is noted that in one or more embodiments, the sensing component 210, recording component 212, determining component 214, mapping component 216, outputting component 218, storing component 220, analytical model 222 and/or training component 224 can be implemented independently, without one or more other of the sensing component 210, recording component 212, determining component 214, mapping component 216, outputting component 218, storing component 220, analytical model 222 and/or training component 224. Additionally and/or alternatively, the sensing component 210, recording component 212, determining component 214, mapping component 216, outputting component 218, storing component 220, analytical model 222 and/or training component 224 can be comprised by a analyzing component 203, one or more of the below-described functions of the sensing component 210, recording component 212, determining component 214, mapping component 216, outputting component 218, storing component 220, analytical model 222 and/or training component 224 can be performed by the analyzing component 203, and/or the sensing component 210, recording component 212, determining component 214, mapping component 216, outputting component 218, storing component 220, analytical model 222 and/or training component 224 can be omitted with the analyzing component 203 performing one or more of the below-described functions of the one or more omitted sensing component 210, recording component 212, determining component 214, mapping component 216, outputting component 218, storing component 220, analytical model 222 and/or training component 224.

Turning first to the sensing component 210, this component can employ one or more microphones 257 and/or other like devices to receive audio and/or sounds signals 234, such as comprising and/or comprised by voice soundwaves 242. Signals received can be referred to as sensed signals 272. It will be appreciated that employing technology understood by one having ordinary skill in the art, the sensed signals 272 can be converted into suitable signal data 274 (e.g., data and/or metadata). The sensed signals 272 can be converted into the signal data 274 by a recording device 256 and/or by the conversation analysis system 202.

As used herein, a recording device 256 can be any suitable computing device, such as, but not limited to, a laptop, phone, tablet, personal computer, recorder, etc. A recording device 256 can comprise one or more sensors 258, such as sound, light, motion accelerometer, touch, etc. Additionally and/or alternatively, an audio and/or video sensor 258 can be any suitable sensor for detecting and/or recording audio and/or video signals 234, comprising at least voice soundwaves 242 originating from various origination sources 240, such as participant entities 232.

A recording device 256 can comprise one or more microphones 257 and/or one or more cameras for recording sound and/or video. One or more lights 259 can be employed such as to provide notification to a user entity and/or participant entity 232 that recording is occurring or that recording is not yet occurring. Any one or more audio and/or video sensors 258, other sensors 258, lights 259 and/or microphone 257 can be controlled by one or more respective processors of a recording device 256.

It is noted that in any of the above examples, the recording device 256 can comprise the conversation analysis system 202 and/or be separate from but communicatively coupled to the conversation analysis system 202. Where the recording device 256 comprises the conversation analysis system 202, one or more processes such as recording, analyzing, determining, etc., can be performed by the conversation analysis 202 even where the recording device 256 is in a respective dormant state.

In connection therewith, it will be appreciated that the sensing component 210 can be comprised by the conversation analysis system 202 with a sensor (e.g., audio and/or video sensor 258) and/or microphone 257 provided at a recording device 256, comprised by a recording device 256 comprising an audio and/or video sensor 258 and/or microphone 257, and/or comprised by the conversation analysis system 202 with an audio and/or video sensor 258 and/or microphone 257 also provided at the conversation analysis system 202.

In one or more embodiments, the sensing component 210 likewise can generally determine that recording of signals 234, such as voice soundwaves 242, should be triggered and/or can send a signal to trigger the recording. Various aspects of an environment 250 can be sensed (e.g., sound signals 234, touch signal, time, location, etc., to be explained below), where data corresponding to such sensing can be employed by the recording component 212 to trigger recording of a conversations 236.

For example, in one or more embodiments, a sensor 258 can detect manual contact and/or movement of a recording device 256 comprising the sensor 258. Accordingly, such sensor 258 can comprise and/or be a touch sensor allowing for sensing of manual contact of any suitable type (tap, swipe, press, hold, and/or combination thereof with or without varying pressure/force requirements). Alternatively, and/or additionally, such sensor 258 can comprise and/or be an accelerometer, allowing for sensing of stoppage of movement of the sensor 258/recording device 256, such as where the recording device 256 is placed down at a location 252 of a conversation 236 (e.g., placed on a table thereat).

In one or more embodiments, entrance of a recording device 256 into a dormant state can cause triggering of recording by the recording component 212, such as with the sensing component 210 sending a notification and/or signal to the recording component 212 (and/or making such available thereto) to cause the recording.

As used herein, a dormant state can refer to a deactivated state, such as of a keyboard, screen, etc. and/or a sleep state, such as of an operating system, of a recording device 256. It is noted that one or more processes still can be operating, such as by and/or directed by a processor, while a keyboard, screen, etc. is not in use and the computing device is in a corresponding dormant state. Additionally, and/or alternatively, a dormant state can correspond to closing of a laptop clamshell/lid, placing of a tablet or phone in a particular position (e.g., face down), etc.

In one or more embodiments, a determination 271 can be made that signals 234 being sensed correspond to classification data 282C for a current conversation 236, such as matching a location of the recording device 256, participants 232 scheduled for a conversation 236, time of the conversation 236, etc. For example, a voiceprint 244 corresponding to a participant 232 can be leveraged to cause triggering of recording by the recording component 212. It is noted that obtaining of the classification data 282 (e.g., 282C) and analyzing of sensed signals 272 based on the classification data 282, thus resulting in the determination 271, will be discussed below in detail relative to the determining component 214 and/or analytical model 222 of the conversation analysis system 202.

Additionally, and/or alternatively, in any one or more of the above examples, the sensing component 210, recording component 212 and/or determining component 214 can be comprised by and/or function in cooperation with, an analytical model 222. For example, the analytical model 222 can employ and/or comprise the determining component 214 and can recognize the voice soundwaves 242 as corresponding to a particular voiceprint 244 associated with a participant 232 that is determined to be part of a conversation 236 on a schedule (e.g., the schedule and list of participants 232 can be comprised by current classification data 282C obtained by the determining component 214 and/or analytical model 222).

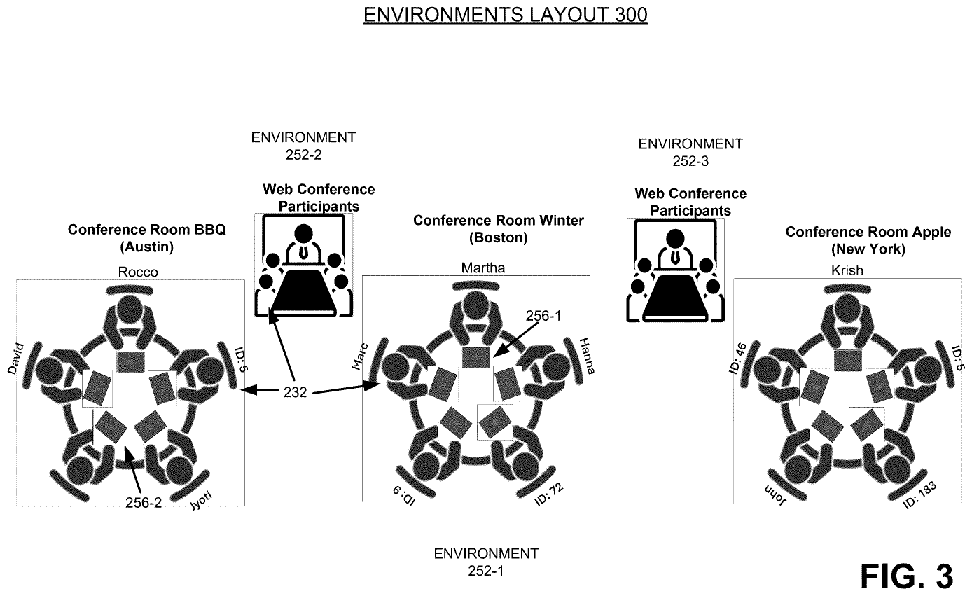

Prior to discussion of recording and analyzing of signals 234, sensed signals 272 and/or signal data 274, discussion first turns to FIG. 3 and to an environmental layout 300 corresponding to the conversation 236 (e.g., the environment of the conversation 236). Description of the environmental layout 300 will be provided to provide background for the various processes that can be performed by the conversation analysis system 202, such as triggering of recording, recording of sensed signals 272 as signal data 274, obtaining of classification data 282, analysis of signal data 274, determination of one or more origination sources 240, determination of one or more locations 252 and/or environments 250, generating of environmental map data 284 that can comprise graph data 292 relating locations of origination sources to one another, and/or generating of one or more responses 296 to one or more queries 294.

At FIG. 3, various environments are interconnected via one or more networks 254. For example, a first environment 252-1 can comprise a first group of participants 232. For purposes of illustration only, the participants of the first environment 252-1 are located at a set of three tables spaced apart from one another. The second environment 252-2 and the third environment 252-3 are separated from one another, such as where the second environment 252-2 and the third environment 252-3 are streamed into the first environment 252-1 via the network 254. It will of course be appreciated that relative to any one environment 252, each of the other environments can be streamed to such one environment 252.

In the environments layout 300, any one or more participants 232 can have associated therewith a recording device 256, such as the recording devices 256-1 and 256-2 in the first environment 252-1.

Relative to the conversation 236 to occur and/or occurring at the environments layout 300, classification data 282, such as current classification data 282C can be associated therewith that defines the conversation 236. Such classification data 236 can be comprised by a suitable scheduling medium, such as a program, application, software, container, etc. and can be temporarily and/or permanently stored at any suitable location such as the memory 204, information datastore 240, etc. Location of storage can be internal and/or external to the conversation analysis system 202, but at least communicatively accessible by and/or to the conversation analysis system 202. The classification data 282/specifications 282S can comprise data and/or metadata in any suitable format.

Turning briefly to FIG. 5, specifications 282S that can be comprised by the classification data 282 can comprise, but are not limited to a meeting (e.g., conversation) title, meeting time, meeting date, participants, participant locations, participant relationships, relationships between participants and recording devices, relationship to a prior meeting and/or streaming and/or audio medium specification.

In one or more cases, additional classification data 282 can be comprised by and/or at a suitable storage location of the recording device, such as including, but not limited to computing device specifications, machine telemetry, internal clock timing, etc. These types of specifications can be employed by the conversation analysis system 202 for context, identification of participants, locations of environments relative to one another, etc.

Still referring to FIG. 3, with respect to the insights and/or query responses obtainable from the conversation analysis system 202, as compared to existing frameworks, such insights and/or query responses that can be desirable can comprise, but are not limited to, determination of attending participants (whether scheduled to attend or not scheduled to attend), recording device specifications, locations of participants relative to one another in a full environments layout 300 and/or in a single environment 252, locations of environments relative to one another, correspondences of voiceprints to aspects of information discussed, and/or correspondences (e.g., relationships) among participants 232 and/or among the current conversation 236 and previous/prior conversations. These various insights and/or query responses can be provided using the conversation analysis system 202 and associated methods described herein.

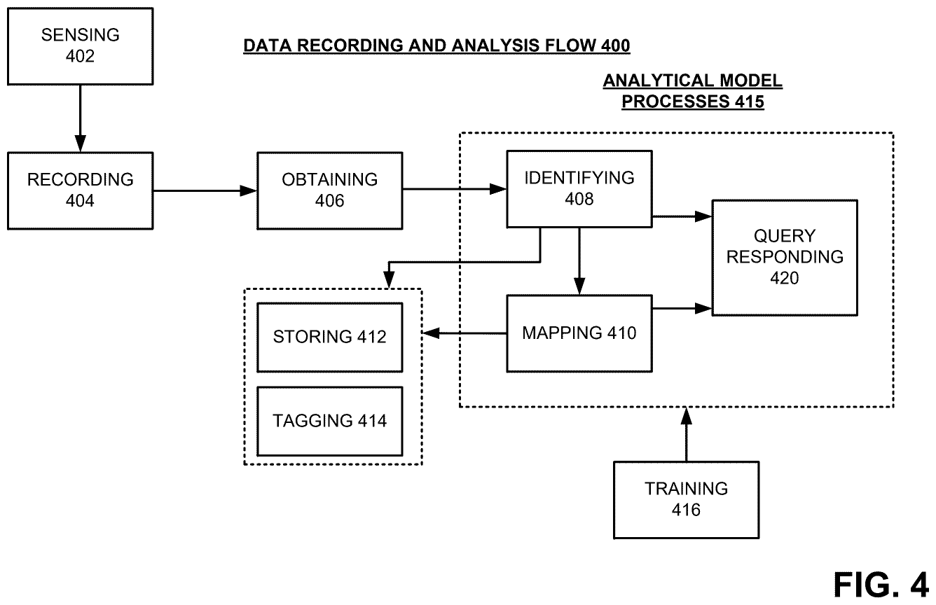

For example, as a brief roadmap of discussion to be provided below, reference is next made to the data recording and analysis flow 400 of FIG. 4. At FIG. 4, various processes are illustrated that can be performed by the conversation analysis system 202, including one or more processes that can be performed by an analytical model 222 of the conversation analysis system 202.

For example, at the flow 400, a sensing process 402 can trigger a recording process 404, which can trigger an obtaining process 406 of classification data 282 (e.g., 282C, 282P, 282S etc.). Analysis and/or determining processes can be performed next by the conversation analysis system with or without use of an analytical model 222. With an analytical model 222, various analytical model processes 415 can comprise, but are not limited to identifying processes 408 for identifying of one or more participants 232, locations 252, environment 250, recording devices 256, etc.

The analytical model processes 415 can comprise mapping of locations of participants 232, recording devices 256 and/or environments 250 relative to one another, and/or mapping of relationships between participants 232, recording devices 256, environments 250 and/or multiple conversations 236.

The analytical model processes 415 can comprise query responding processes 420, such as responding to one or more queries 295 that are submitted via chatbot, submission form, application programming interface, voice to text, command line, browser, etc.

One or more of these analytical model processes 415 can be based on training processes 416 of the analytical model 222 by a training component 224. As noted above, an analytical model 222 can comprise, but is not limited to an artificial intelligence model, neural network model, machine learning model, language model, and/or the like, such as employing one or more layers of neurons to store and access data using one or more algorithms and/or specified parameters. This can provide for a set of rules and calculations that process data to make predictions based on patterns learned, by the analytical model 22 from training processes 416 employing training data.

Training data can comprise artificially generated data (e.g., not based on a real conversation) and/or historical data, such as historical classification data 282C. Historical classification data 282C can comprise information corresponding to any one or more of the specifications 282S previously discussed above, including, but not limited to voiceprint identification, participants that attend conversations together, locations at which participants are known to attend conversations, etc.

Resulting from the one or more analytical model processes 415 can be various processes including, but not limited to, storing processes 412 for storing of signal data 254 and/or for storing of metadata determined from the identifying and/or mapping processing 208, 210, storing and/or tagging (e.g., 414) of environmental map data 284 and/or classification data 282 relative to one another, generating of graph data 292 based on the environmental map data 284, etc.

With respect to the roadmap flow 400 of FIG. 4, using the conversation analysis system 202 of FIG. 2, and with respect to the environmental layout 300 of FIG. 3 of a conversation 236, discussion now turns to the recording component 212, which can, based on sensed signals 272 corresponding to a conversation 236, where the sensed signals 272 at least partially correspond to voice soundwaves 242 comprised in the conversation 236, record the sensed signals 272 as signal data 272. It will be appreciated that the signals 234 themselves can be sensed by the conversation analysis system 202 and/or by a recording device 256 communicatively coupled to the conversation analysis system 202, such as where the signals 234 are transmitted to the conversation analysis system 202 for the recording. The recording can be to the memory 204 and/or to a datastore 240 comprised by and/or separate from the conversation analysis system 202. The signal data 274 can be stored in any suitable format (including data and/or metadata) and can comprise any suitable tags 278 such as timestamps.

The determining component 214 can analyze the signal data 274 based on classification data 282, 282C representative of at least one specification 282S determined to be applicable to the conversation 236. That is, the classification data 182, such as current classification data 182 that is applicable to the conversation 236, can be obtained by the determining component 214 and/or any other aspect of the conversation analysis system 202. Looking again briefly to FIG. 5 as refresher, the classification data 282 can comprise any one or more specifications 282C comprising a meeting (e.g., conversation) title, meeting time, meeting date, participants, participant locations, participant relationships, relationship to a prior meeting and/or streaming and/or audio medium specification. The classification data 282/specifications 282S can comprise data and/or metadata in any suitable format.

In one or more embodiments, the determining component 214 can search for classification data 282 that is not yet stored at the information datastore 240 (and/or other location of storage employed by the conversation analysis system 202) at any suitable frequency and/or on demand. In this way, the conversation analysis system 202 can have obtained data defining a conversation 236 prior to the conversation occurring, such as to employ for triggering of recording of the conversation 236, as described above, and/or to employ for making one or more determinations 271 relative to any one or more other conversations 236.

As mentioned above, the analytical model 222 can employ output from the determining component 214 and/or comprise the determining component 214. In one or more embodiments, the analytical model 22 can comprise any one or more of the determining component 214, mapping component 216, outputting component 218 and/or storing component 220. In one or more embodiments, the analytical model 222 can perform one or more processes described herein as being performed by the determining component 214, mapping component 216, outputting component 218 and/or storing component 220.

For example, using the determining component 214, the analytical model 222/determining component 214 can determine a voiceprint 244 associated with voice sound waves 242 (e.g., associated with signal data 274 and/or signal metadata 276 corresponding to the voice sound waves 242). A voiceprint can be determined based on previous classification data 282P learned by the analytical model 222 and/or predicted, by the analytical model 222, based on current classification data 282C learned by the analytical model 222 for the current conversation 236.

Where a voiceprint is yet unknown and is not able to be identified from any classification data 282, the determining component 214/analytical model 222 can generate a unique user profile identification in any suitable form (numeric or otherwise). This unique user profile identification can serve as a voiceprint identification 244 until a prediction is made by the analytical model 222 and/or until a user entity provides information further tagging and/or defining the unique user profile identification. It will be appreciated that a user profile can comprise and/or be a voiceprint. Using the storing component 220, this voiceprint data can be stored as classification data 282P, such as in a catalog, for use by the conversation analysis system 202. Alternatively, where a user profile already exists corresponding to a voiceprint 244 identified, any modifications, such as predicted voiceprint changes, can be saved to the user profile by the storing component 220.

Additionally, and/or alternatively, multiple voiceprints 244 can be stored for a single user profile/origination source 240. For example, a participant 232 can be sick for the recording of first voice soundwaves 242 and corresponding voiceprint 244, or an environment 250 of the conversation 236 can have an echo. Accordingly, one or more different voiceprints can be employed, by the determining component 214/analytical model 222, to identify an origination source 240 and/or participant 232 corresponding to one or more voice soundwaves 242/signal data 274.

For another example, using the determining component 214, the analytical model 222/determining component 214 can determine one or more environments 250 associated with the conversation 236. That is, based on the classification data 282C and/or based on analysis of voice soundwaves 242/signal data 274 (e.g., metadata defining streaming of voice soundwaves 242 rather than directly recorded voice soundwaves 242), the analytical model 222/determining component 214 can determine that one or more particular environments are participating in the conversation 236. Similar to the voiceprints as discussed above, an environment profile can be created, updated, modified, saved, etc. to allow for current and/or future determinations 271.

For another example, using the determining component 214, the analytical model 222/determining component 214 can determine one or more locations 252 of participants 232, environments 250 and/or recording devices 256 relative to one another at a timepoint during the conversation 236. For example, the analytical model 222 can employ one or more voice and/or sound recognition processes understood by one having ordinary skill in the art to determine one or more proximities of one or more participants 232, locations 252 (e.g., different tables at FIG. 3) and/or environments 252 relative to one another. In addition, referring to the environments layout 300 of FIG. 3 as an example, proximity or non-proximity of one or more origination sources 240 to one another can allow for determination of one or more environments 250 and/or voiceprints 244. For example, the analytical model 222 can recognize that certain participants 232 are historically within proximity or non-proximity of one another.

For example, a participant's computing device (e.g., recording device 256) can be listening and transcribing speech from the surrounding environment 250. When the analytical model 222 detects a voiceprint 244 that is yet to be identified, it can save off an audio sample of the voiceprint 244 and assign the voiceprint 244 a temporary identification to be associated in the transcribed data being persisted at the recording device 256. If connectivity to the conversation analysis system 202 and/or storage server (e.g., information datastore 240) is available, the analytical model 222 can send the audio sample to the server and attempt to request an identification for a participant 232 matching the voiceprint 244. Recall above that a new user can have a user profile saved that will include a voiceprint. If there is a match determined (e.g., determination 271 by the analytical model 222), then a user profile identification can be sent back in response, and the locally transcribed speech to text data for that participant 232 can be tagged relative to the identification and voiceprint 244. That is, user detection can allow for more precise speech-to-text processing than can be performed by existing frameworks.

This location data can be aggregated with recording device 256 location data, such as where a geolocation or other location-based identifier of a recording device 256 is determined as being located within a proximity of one or more participants 232, such as based on the recorded signal data 274 and any underlying signal metadata 276.

For still another example, using the previous classification data 282P, the analytical model can determine any one or more of the above determinations 271 of voiceprint 244, location 252 and/or environment 250 based on correspondences between voiceprint 244, location 252 and/or environment 250 of the current conversation 236 and voiceprint 244, location 252 and/or environment 250 of a previous conversation 236. For example, participants can often attend a conversation together 236, or a participant 232 can employ a particular location 252 for conversations 236. This correspondence-based metadata can be determined, learned, and/or trained relative to the analytical model 222 and stored as one or more tags 278 and/or other metadata of the previous classification data 282P.

It will be appreciated that one or more aspects of the identifying processes 208 can be performed prior to recording, such as based on temporary signal data 274 storing and/or analysis. This can be performed to allow for triggering of recording by the recording component 212, such as based on recognition of a voiceprint 244 that is known by the analytical model 222 to be participating in the conversation 236 to be recorded. Such information can be coupled with a location 252 of the recording device 256 obtained by the analytical model 222, such as where the recording device 256 is in the location 252 for the conversation 236 specified in classification data 282 for the conversation 236. Additionally, and/or alternatively, such information can be coupled with a current timestamp matching, such as within a specified deviation (e.g., conversation starts late or early) corresponding to a time classification data 282 for the conversation 236.

In one or more embodiments, the analytical model 222/determining component 214 can employ signal data 274 recorded from multiple microphones 257 and/or sensors 258 at a single recording device 256. For example, a recording device 256 with multiple strategically placed microphones 257, such as multiple directional microphones 257, can be employed and can provide an opportunity for sound position tracking to determine participant 232 location 252 relative to the recording device 256, and sound focus to capture voice soundwaves 242 from specific locations 252 within an environment 250 at which the conversation 236 is taking place.

In one or more embodiments, the analytical model 222/determining component 214 can employ signal data 274 recorded from multiple recording devices 256 corresponding to a same conversation 236. The recorded signal data 274 can be recorded at overlapping and/or non-overlapping time ranges. Position of one recording device, such as 256-1 relative to another recording device, such as 256-2 (e.g., at the example illustration of FIG. 3), can allow for higher accuracy and/or precision of one or more determinations 271 discussed above. For example, using signal data 274 recorded from two different recording devices 256, a location of a participant 232 and/or origination source 240 can be predicted.

In one or more cases, a set of multiple recording devices 256 can comprise a web-based and/or application-based recording aspect (e.g., software and/or firmware) comprised by a recording, transmitting and/or conference streaming medium. Thus, signal data 274 recorded can comprise such web conference data.

Turning now to the mapping component 216, this component can generally, based on the analyzing, map the signal data 174 to an origination source 140 representative of an origin of the sensed signals 172. That is, one or more origination sources 140 can be the one or more respective origins for voice soundwaves 142/signals 134 detected as the sensed signals 172. The origination source 140 can be a participant entity, for example, to the conversation 136.

The mapping can be output as environmental map data 284, such as in a format similar to that illustrated at FIG. 3, such as comprising location data 286 representative of respective locations 252 of the respective origination sources 240 relative to one another.

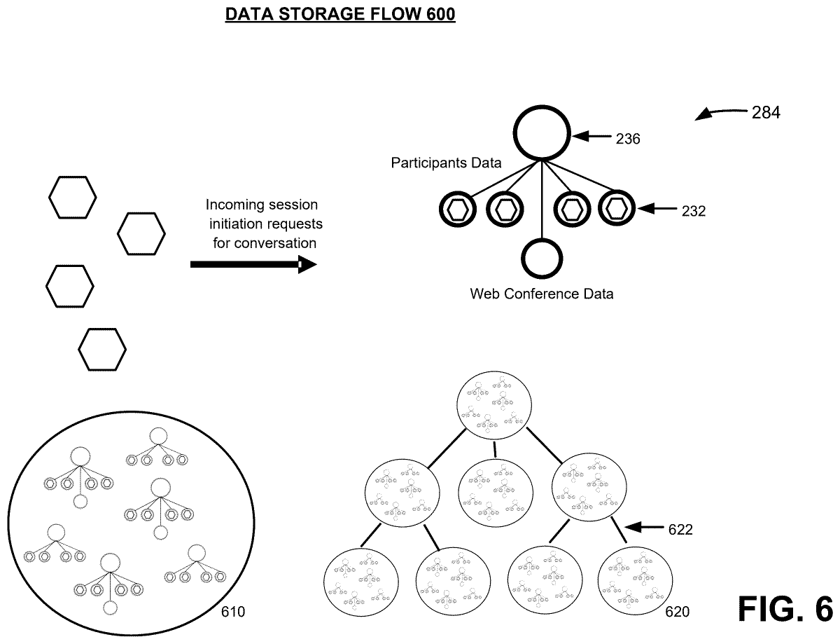

For example, turning to FIG. 6, illustrated is a data storage flow 600 illustrating a method of data gathering and storage that can be employed by the analytical model 222 and determining component 214, mapping component 216 and/or storing component 220.

Generally, environmental mapping data 284 for a single conversation 236 can be stored in a single file and/or associated with one another. Two or more conversation datasets from multiple conversations 236 can be grouped in a conversation group 610 such as based on information discussed and determined by the analytical model 222 using speech to text analysis understood by one having ordinary skill in the art. Further, in one or more cases, multiple groups 610 of conversations can be mapped as a conversation tree 620, such as based on correspondences 622 based on information discussed and/or time range of the corresponding conversations 236.

For example, in one or more embodiments, a recording device 256 can initialize and then continuously performs speech to text and transcribe collection. At some point, a connection with a remote server can occur to transfer the collected sensed signals 272 and/or signal data 274 to allow for aggregation and/or organization by the determining component 214 and/or analytical model 222.

In the example, where there is connectivity available from recording devices 256, information can be sent to a server and/or information datastore 240. A first recording device 256 to send a collection request to the server can provoke the server (e.g., determining component 214) to generate a new conversation entry in order to aggregate any subsequent recording device transcription requests to be associated with the new conversation. Additionally, the server (e.g., determining component 214) can actively (e.g., absent on-demand direction to do so) analyze the signal data 274 collected and attempt to associate the signal data 274 with other signal data 274 from other conversations (e.g., previous classification data 282P), such as to expand the context and relationships determined by the analytical model 222. This can allow for expansion of the value of the insights that can then be obtained from all the aggregated meetings transcriptions as compared to existing frameworks that cannot provide these processes.

If there is also a web conference involved for the meeting and the vendor makes available the transcribed data and/or related signal data 274, this also can be sent to the server, along with any participant, environment and/or location identification information provided by the vendor. It is noted that the determining component 214 can be authorized to obtain this signal data 274 and/or send a request for the signal data 274 to the vendor.

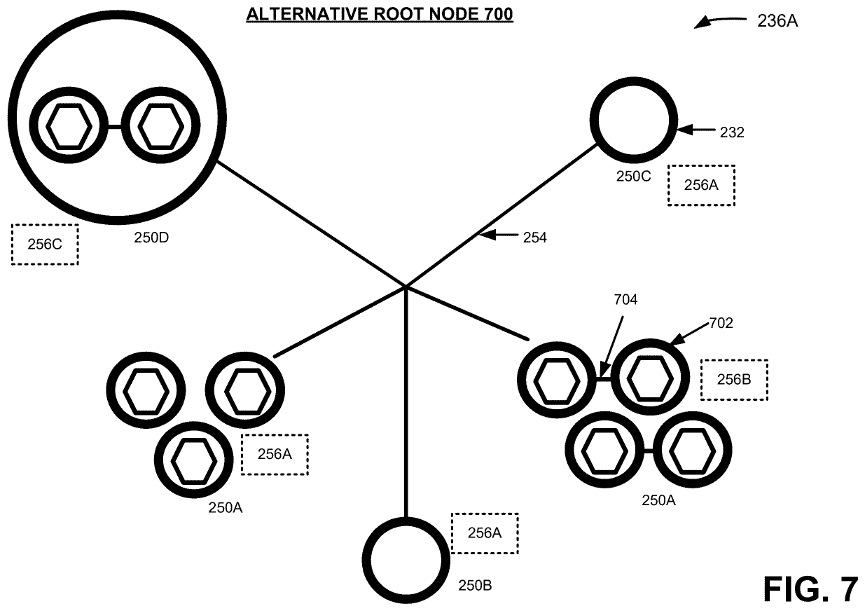

Turning next to FIG. 7, illustrated is an alterative root node for a single conversation 236A that can comprise graph data 292 allowing for greater specificity of insights based on determinations 271 made by the analytical model 222 and/or conversation analysis system 202. For example, the graph 236A can comprise nodes 702 corresponding to the respective origination sources 240 and edges 704 corresponding to the respective locations 252 of the respective origination sources 240 relative to one another. It is appreciated that the graph data 292 can be stored in any form and need not be stored in the form illustrated at FIG. 7. However, the outputting component 218 can output the graph data 292, such as illustrated at FIG. 7, for efficient viewing and understanding by a participant entity and/or other user entity, such as to any graphical user interface communicatively coupled to the conversation analysis system 202.

Referring next to the outputting component 218, this component can generally output one or more responses 296 as response data, in response to receiving one or more queries 295 as query data 294. For example, the analytical model 222 can comprise and/or be associated with a browser, command line, chatbot, application interface, etc., allowing for queries relating to voiceprint 244, location, network 254 and/or environment 250 to be received by the analytical model 222 and responded to by the analytical model 222, using the current classification data 282C, previous classification data 282P (including that from the recent conversation 236) and/or signal data. Indeed, any one or more responses 296 generated by the analytical model 222 and output by the outputting component 218 can employ any one or more determinations 271 from the analytical model 222, as discussed above.

Next, turning to the storing component 220, while already discussed above, it is noted that any insights, responses 296, signal data 274, environmental map data 284, graph data 292, query data 294, and/or new and/or updated voiceprints 244, locations 252 and/or environments 250 and/or data related thereto can be stored at any suitable location for future use by the conversation analysis system 202. For example, any one or more such aspects of information can be stored as previous classification data 282P at the information datastore 240.

Finally, discussion turns to conclusion of participant participation in a conversation 236 and conclusion of a conversation 236. Any one or more of the processes noted above for triggering recording can be employed for triggering ending of recording. For example, a sensor 258 (e.g., accelerometer) can be employed to sense start of motion leading to triggering of end of recording. It is noted that where a recording device 256 associated with a participant 232 is determined as no longer being in the conversation 236, it can be determined, such as by the analytical model 222, that that participant 232 has left the conversation.

Likewise, a conversation can be ended and one or more notes and/or tags added to the associated file by the storing component 220 based on classification data 282. For cases where the analytical model 222 and/or storage component 220 detects that it does not have all the data from all the participants 232 and/or recording devices 256, such as due to network connectivity, the data got lost or corrupted, participant 232 was not present at the conversation 236, then the analytical model 222 and/or storage component 220 can set a status for that participant 232 and/or recording device 256 and generate a notification of insights limitations due to this condition.

### EXAMPLE OPERATIONS

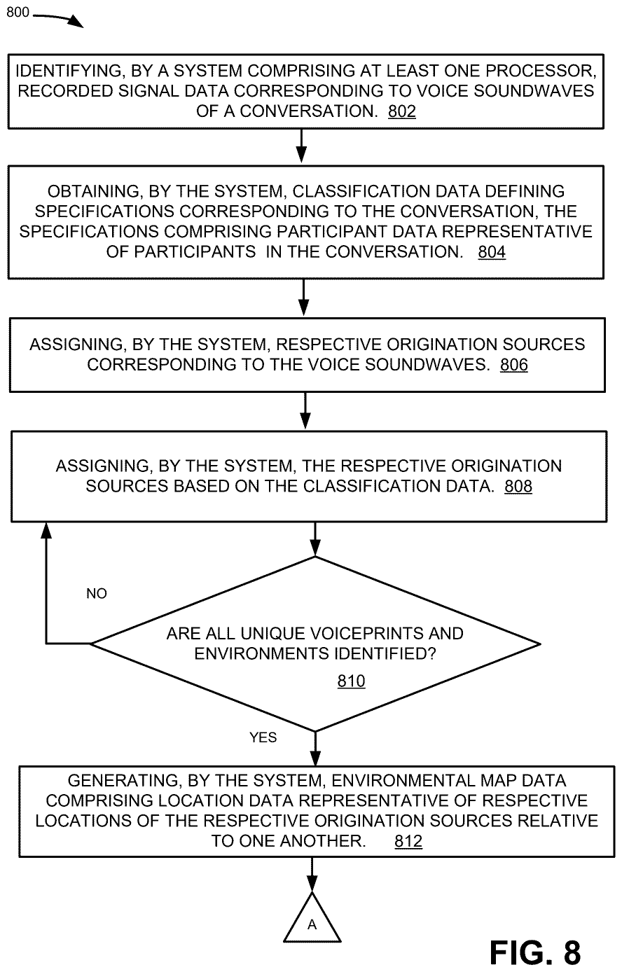

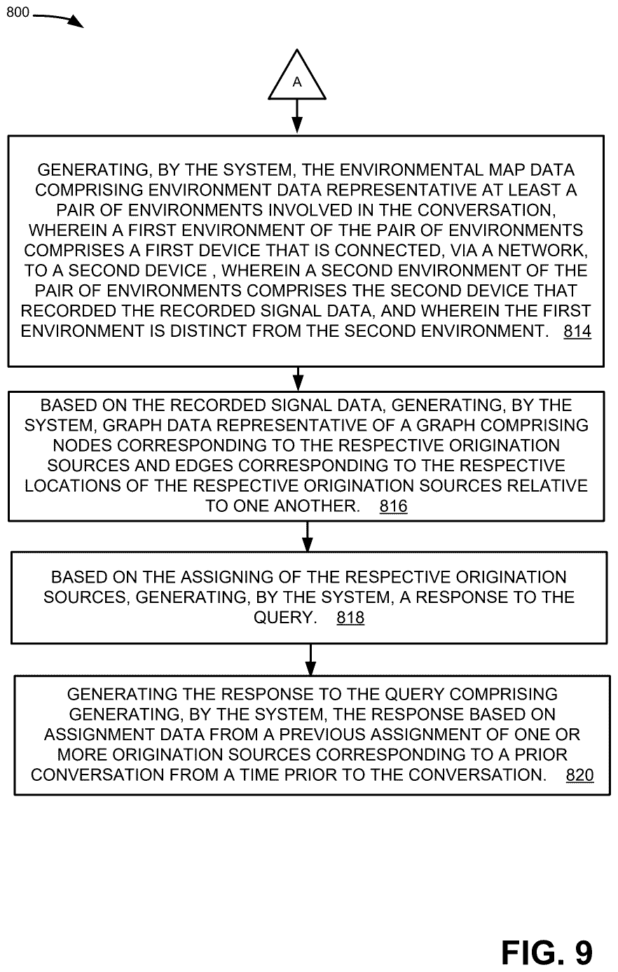

As a first summary of the above description relative to FIGS. 1-8, turning now to FIGS. 8 and 9, a process flow comprising a set of operations for conversation analysis that can employ the non-limiting system 100 of FIG. 1 or the non-limiting system 200 of FIG. 2. For sake of brevity, the process flow 800 will be described below relative to the non-limiting system 200 of FIG. 2. One or more elements, objects and/or components referenced in the process flow 800 can be those of FIGS. 1-7. Repetitive description of like elements and/or processes employed in previously described embodiments is omitted for sake of brevity.

At operation 802, the process flow 800 can comprise identifying, by a system comprising at least one processor (e.g., processor 206) (e.g., recording component 212), recorded signal data (e.g., signal data 274) corresponding to voice soundwaves (e.g., voice soundwaves 242) of a conversation (e.g., conversation 236).

At operation 804, the process flow 800 can comprise obtaining, by the system (e.g., determining component 214 and/or analytical model 222), classification data (e.g., classification data 282, 282C) defining specifications (e.g., specifications 282S) corresponding to the conversation, the specifications comprising participant data representative of participants (e.g., participants 232) in the conversation.

At operation 806, the process flow 800 can comprise assigning, by the system (determining component 214 and/or analytical model 222), respective origination sources (e.g., origination sources 240) corresponding to the voice soundwaves.

At operation 808, the process flow 800 can comprise assigning, by the system (determining component 214 and/or analytical model 222), the respective origination sources based on the classification data.

At operation 810, the process flow 800 can comprise determining, by the system (e.g., determining component 214), whether or not all unique voiceprints have been identified and whether or not all unique environments have been identified. If yes, the process flow 800 can proceed to step 814. If not, the process flow 800 can proceed back to step 812.

At operation 812, the process flow 800 can comprise generating, by the system (e.g., mapping component 216), environmental map data (e.g., environmental map data 284) comprising location data (e.g., location data 286) representative of respective locations (e.g., locations 252) of the respective origination sources relative to one another.

At operation 814, the process flow 800 can comprise generating, by the system (e.g., mapping component 216), the environmental map data comprising environment data representative at least a pair of environments (e.g., environment 250) involved in the conversation, wherein a first environment of the pair of environments comprises a first device (e.g., first recording device 256) that is connected, via a network (e.g., network 254), to a second device (e.g., second recording device 256), wherein a second environment of the pair of environments comprises the second device that recorded the recorded signal data, and wherein the first environment is distinct from the second environment.

At operation 816, the process flow 800 can comprise, based on the recorded signal data, generating, by the system (e.g., outputting component 218), graph data (e.g., graph data 292) representative of a graph (e.g., graph 236A) comprising nodes (e.g., nodes 702) corresponding to the respective origination sources and edges (e.g., edges 704) corresponding to the respective locations of the respective origination sources relative to one another.

At operation 816, the process flow 800 can comprise receiving, by the system (e.g., analytical model 222 and/or processor 206), query data (e.g., query data 294) comprising a query (e.g., query 295) requesting an origination source, of the respective origination sources, corresponding to a specified time period corresponding to occurrence of the conversation.

At operation 818, the process flow 800 can comprise, based on the assigning of the respective origination sources, generating, by the system (e.g., outputting component 218 and/or analytical model 222), a response (e.g., response 296) to the query.

At operation 820, the process flow 800 can comprise generating the response to the query comprising generating, by the system (e.g., outputting component 218 and/or analytical model 222), the response based on assignment data (e.g., previous classification data 282P) from a previous assignment of one or more origination sources corresponding to a prior conversation from a time prior to the conversation.

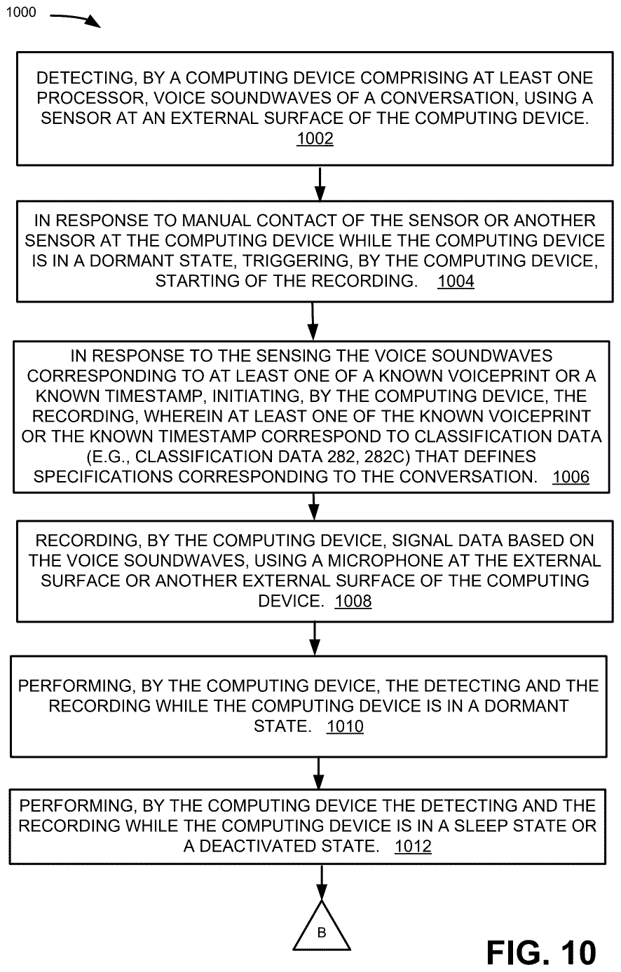

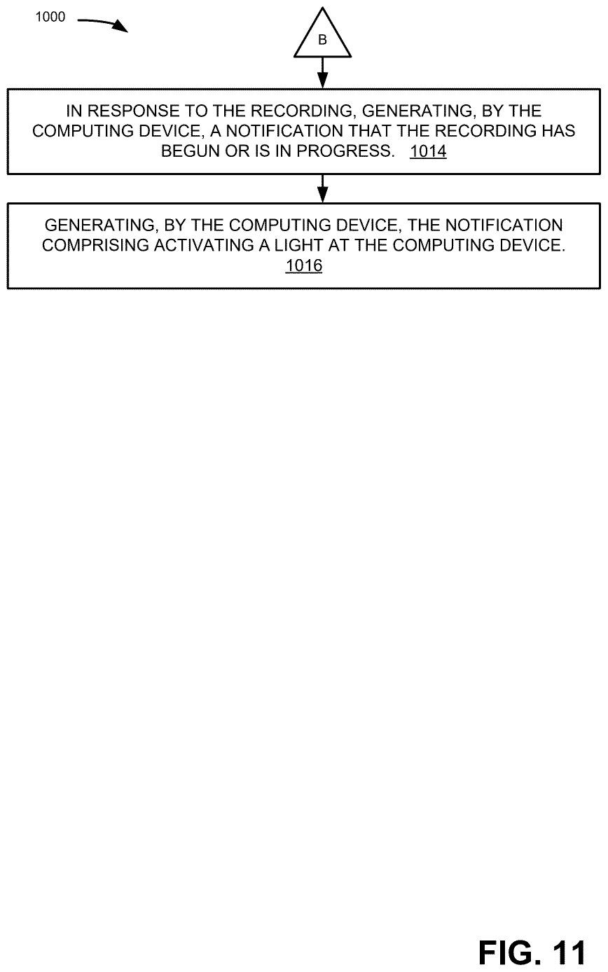

As a second summary of the above description relative to FIGS. 1-4, turning now to FIGS. 10 to 11, a process flow comprising a set of operations for conversation analysis that can employ the non-limiting system 100 of FIG. 1 or the non-limiting system 200 of FIG. 2. For sake of brevity, the process flow 1000 will be described below relative to the non-limiting system 200 of FIG. 2. One or more elements, objects and/or components referenced in the process flow 1000 can be those of FIGS. 1-7. Repetitive description of like elements and/or processes employed in previously described embodiments is omitted for sake of brevity.

At operation 1002, the process flow 1000 can comprise detecting, by a computing device (e.g., sensing component 212 of a recording device 256) comprising at least one processor (e.g., processor 206), voice soundwaves (e.g., voice soundwaves 242) of a conversation (e.g., conversation 236), using a sensor (e.g., sensor 258) at an external surface of the computing device.

At operation 1004, the process flow 1000 can comprise, in response to manual contact of the sensor or another sensor (e.g., another sensor 258) at the computing device while the computing device is in a dormant state, triggering, by the computing device (e.g., recording component 212), starting of the recording.

At operation 1006, the process flow 1000 can comprise, in response to the sensing the voice soundwaves corresponding to at least one of a known voiceprint (e.g., voiceprint 244) or a known timestamp (e.g., specification 282S), initiating, by the computing device (e.g., recording component 212), the recording, wherein at least one of the known voiceprint or the known timestamp correspond to classification data (e.g., classification data 282, 282C) that defines specifications (e.g., specifications 282S) corresponding to the conversation.

At operation 1008, the process flow 1000 can comprise recording, by the computing device (e.g., recording component 212), signal data based on the voice soundwaves, using a microphone at the external surface or another external surface of the computing device.

At operation 1010, the process flow 1000 can comprise performing, by the computing device (e.g., sensing component 210 and recording component 212), the detecting and the recording while the computing device is in a dormant state.

At operation 1012, the process flow 1000 can comprise performing, by the computing device (e.g., sensing component 210 and recording component 212), the detecting and the recording while the computing device is in a sleep state or a deactivated state.

At operation 1014, the process flow 1000 can comprise, in response to the recording, generating, by the computing device (e.g., recording component 212), a notification (e.g., notification 290) that the recording has begun or is in progress.

At operation 1016, the process flow 1000 can comprise generating, by the computing device (e.g., recording component 212), the notification comprising activating a light (e.g., light 259) at the computing device.

For simplicity of explanation, the computer-implemented methodologies and/or processes provided herein are depicted and/or described as a series of acts. The subject innovation is not limited by the acts illustrated and/or by the order of acts, for example acts can occur in one or more orders and/or concurrently, and with other acts not presented and described herein. The operations of process flows of the figures provided herein are example operations, and there can be one or more embodiments that implement more or fewer operations than are depicted.

Furthermore, not all illustrated acts can be utilized to implement the computer-implemented methodologies in accordance with the described subject matter. In addition, the computer-implemented methodologies could alternatively be represented as a series of interrelated states via a state diagram or events. Additionally, the computer-implemented methodologies described hereinafter and throughout this specification are capable of being stored on an article of manufacture to facilitate transporting and transferring the computer-implemented methodologies to computers. The term article of manufacture, as used herein, is intended to encompass a computer program accessible from any machine-readable device or storage media.

In summary, described is a technology that can facilitate conversation analysis using voiceprint identification. For instance, operations can be performed, comprising, based on sensed signals 172, 272, corresponding to a conversation 136, 236, wherein the sensed signals 172, 272 at least partially correspond to voice soundwaves 142, 242 comprised in the conversation 136, 236, recording the sensed signals 172, 272 as signal data 174, 274. Operations can further comprise analyzing the signal data 174, 274 based on classification data 182, 282 representative of at least one specification 182S, 282S determined to be applicable to the conversation 136, 236 and based on the analyzing, mapping the signal data 174, 274 to an origination source 140, 240 representative of an origin of the sensed signals 172, 272.

Indeed, in view of the one or more embodiments described herein, a practical application of the above-indicated method, system and/or non-transitory computer-readable medium can be an ability to analyze conversation data recorded from a conversation and provide outputs further defining various aspects of the conversation (e.g., information discussed, environments of the conversation, participants of the conversation, etc.). For example, based on analysis of the recorded conversation, hardware specifications of recording devices, classification data comprising conversation specifications, etc., one or more voiceprints, origination sources, correspondences of voiceprints to origination locations, locations of origination sources relative to one another, correspondences of one or more spoken words to one or more voiceprints, etc. one or more queries and/or responses can be facilitated.

Another practical application of one or more of the above-indicated method, system and/or non-transitory computer-readable medium can be an ability to provide the analysis and query response processes based on multiple recordings from different vantages (e.g., locations in a single environment, participant computing devices, network-based recordings, environments, time ranges, etc.).

These are useful and practical applications of computers, thus providing enhanced (e.g., improved and/or optimized) conversation analysis beyond capabilities of existing frameworks. Overall, such tools can constitute a concrete and tangible technical and/or physical improvement in the fields of conversation analysis and querying.

Furthermore, one or more embodiments described herein can be employed in a real-world system based on the disclosed teachings. For example, one or more embodiments described herein can function with a computer system and/or one or more servers for internet, cloud and/or internal/external networks to perform the aforementioned conversation analysis and/or querying based on information collection, collation, and/or storage corresponding to at least voice soundwaves recorded from a conversation and/or classification data defining the conversation. Such classification data can comprise meeting time, meeting location, meeting software and/or other medium, participants, etc. Information collation can comprise, but is not limited to, associating of information among multiple conversations. Further, such information collection, collation and/or storage can be performed for multiple recordings of a same conversation, such as from different vantages.

Further, one or more embodiments described herein are inherently and/or inextricably tied to computer technology and cannot be implemented outside of a computing environment. For example, one or more processes performed by one or more embodiments described herein can more efficiently, and/or more feasibly, provide conversation analysis with varying output information types, as compared to existing frameworks. Systems, computer-implemented methods and/or computer program products facilitating performance of these processes are of great utility in the fields of co conversation analysis and querying and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively record and store audio soundwaves as computer-stored data, access computer-stored data, generate computer data, generate and/or employ an analytical model to evaluate the computer-stored data in view of historical computer-stored data and conversation specifications, and/or communicate with a computer-based interface at a digital level of computerized communication, as the one or more embodiments described herein can facilitate these processes. For example, a human, or even thousands of humans, cannot efficiently, accurately and/or effectively perform even one or more of these processes as can the one or more embodiments described herein. And, neither can the human mind nor a human with pen and paper automatically perform one or more of the processes as conducted by one or more embodiments described herein.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not described herein for the sake of brevity, but known by those of skill in the art.

In one or more embodiments, one or more of the processes described herein can be performed by one or more specialized computers (e.g., a specialized processing unit, a specialized classical computer, and/or another type of specialized computer) to execute defined tasks related to the one or more technologies describe above. One or more embodiments described herein and/or components thereof can be employed to solve new problems that arise through advancements in technologies mentioned above, employment of cloud operation systems, computer architecture and/or another technology.

One or more embodiments described herein can be fully operational towards performing one or more other functions (e.g., fully powered on, fully executed and/or another function) while also performing the one or more operations described herein.

The paragraphs that follow provide additional summary reciting an example system, and a pair of example methods, such as computer-implemented methods, for conversation analysis.

An example system comprises at least one processor, and at least one memory that stores executable instructions that, when executed by the at least one processor, facilitates performance of operations. The operations comprise, based on sensed signals corresponding to a conversation, and where the sensed signals at least partially correspond to voice soundwaves comprised in the conversation, recording the sensed signals as signal data, analyzing the signal data based on classification data representative of at least one specification determined to be applicable to the conversation, and, based on the analyzing mapping the signal data to an origination source representative of an origin of the sensed signals.

With respect to the example system, the origination source is a first origination source, and the operations further comprise identifying a pair of locations, associated with a time period applicable to the conversation, relative to one another, where the pair of locations correspond to the first origination source and a second origination source.

With respect to the example system, the operations further comprise determining that the voice soundwaves comprise a previously unidentified voiceprint for which a corresponding voiceprint has not previously been stored in the classification data.

With respect to the example system, the operations further comprise determining that the sensed signals involved in the conversation are from multiple distinct environments, and also with respect to the example system, the recording of the sensed signals as the signal data comprises recording the sensed signals with metadata representing that the sensed signals are from the multiple distinct environments involved in the conversation.

With respect to the example system, the operations further comprise analyzing the signal data, resulting in a determination that the sensed signals are from multiple recording devices that recorded the conversation.

With respect to the example system, the operations further comprise determining, from the classification data, different voiceprints matching different origination sources, comprising the origination source, during the recording of the signal data.

With respect to the example system, the operations further comprise, in response to sensing a signal via an external sensor of a computing device in a dormant state, starting the recording of the signal data.

With respect to the example system, the mapping comprises, in response to analyzing the signal data, and based on the classification data, associating previously identified voiceprint data, representative of at least one voiceprint previously stored in the classification data, with voiceprint data determined from the analyzing of the signal data, and tagging the signal data to correspond to the voiceprint previously stored in the classification data.

An example method comprises identifying, by a system comprising at least one processor, recorded signal data corresponding to voice soundwaves of a conversation, assigning, by the system, respective origination sources corresponding to the voice soundwaves, and generating, by the system, environmental map data comprising location data representative of respective locations of the respective origination sources relative to one another.

With respect to the example method, the environmental map data further comprises environment data representative at least a pair of environments involved in the conversation. A first environment of the pair of environments comprises a first device that is connected, via a network, to a second device. A second environment of the pair of environments comprises the second device that recorded the recorded signal data. The first environment is distinct from the second environment.

The example method further comprises obtaining, by the system, classification data defining specifications corresponding to the conversation, the specifications comprising participant data representative of participants in the conversation, and assigning, by the system, the respective origination sources based on the classification data.

The example method further comprises, based on the recorded signal data, generating, by the system, graph data representative of a graph comprising nodes corresponding to the respective origination sources and edges corresponding to the respective locations of the respective origination sources relative to one another.

The example method further comprises receiving, by the system, query data comprising a query requesting an origination source, of the respective origination sources, corresponding to a specified time period corresponding to occurrence of the conversation, and based on the assigning of the respective origination sources, generating, by the system, a response to the query.

With respect to the example method, the generating of the response to the query comprises generating the response based on assignment data from a previous assignment of one or more origination sources corresponding to a prior conversation from a time prior to the conversation.

A second example method comprises detecting, by a computing device comprising at least one processor, voice soundwaves of a conversation, using a sensor at an external surface of the computing device, recording, by the computing device, signal data based on the voice soundwaves, using a microphone at the external surface or another external surface of the computing device, and in response to the recording, generating, by the computing device, a notification that the recording has begun or is in progress.

With respect to the second example method, the generating of the notification comprises activating a light at the computing device.

With respect to the second example method, the detecting and the recording are performed while the computing device is in a dormant state.

With respect to the second example method, the dormant state of the computing device corresponds to a deactivated state or a sleep state of the computing device.

The second example method further comprises, in response to manual contact of the sensor or another sensor at the computing device while the computing device is in a dormant state, triggering, by the computing device, starting of the recording.

The second example method further comprises, in response to the sensing the voice soundwaves corresponding to at least one of a known voiceprint or a known timestamp, initiating, by the computing device, the recording. At least one of the known voiceprint or the known timestamp correspond to classification data that defines specifications corresponding to the conversation.

### EXAMPLE OPERATING ENVIRONMENT

FIG. 12 is a schematic block diagram of an operating environment 1200 with which the described subject matter can interact. The operating environment 1200 comprises one or more remote component(s) 1210. The remote component(s) 1210 can be hardware and/or software (e.g., threads, processes, computing devices). In one or more embodiments, remote component(s) 1210 can be a distributed computer system, connected to a local automatic scaling component and/or programs that use the resources of a distributed computer system, via communication framework 1240. Communication framework 1240 can comprise wired network devices, wireless network devices, mobile devices, wearable devices, radio access network devices, gateway devices, femtocell devices, servers, etc.

The operating environment 1200 also comprises one or more local component(s) 1220. The local component(s) 1220 can be hardware and/or software (e.g., threads, processes, computing devices). In one or more embodiments, local component(s) 1220 can comprise an automatic scaling component and/or programs that communicate/use the remote resources 1210 and 1220, etc., connected to a remotely located distributed computing system via communication framework 1240.

One possible communication between a remote component(s) 1210 and a local component(s) 1220 can be in the form of a data packet adapted to be transmitted between two or more computer processes. Another possible communication between a remote component(s) 1210 and a local component(s) 1220 can be in the form of circuit-switched data adapted to be transmitted between two or more computer processes in radio time slots. The operating environment 1200 comprises a communication framework 1240 that can be employed to facilitate communications between the remote component(s) 1210 and the local component(s) 1220, and can comprise an air interface, e.g., interface of a UMTS network, via an LTE network, etc. Remote component(s) 1210 can be operably connected to one or more remote data store(s) 1250, such as a hard drive, solid state drive, subscriber identity module (SIM) card, electronic SIM (eSIM), device memory, etc., that can be employed to store information on the remote component(s) 1210 side of communication framework 1240. Similarly, local component(s) 1220 can be operably connected to one or more local data store(s) 1230, that can be employed to store information on the local component(s) 1220 side of communication framework 1240.

### EXAMPLE COMPUTING ENVIRONMENT

In order to provide additional context for various embodiments described herein, FIG. 13 and the following discussion are intended to provide a brief, general description of a suitable computing environment 1300 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform tasks or implement abstract data types. Moreover, the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Referring still to FIG. 13, the example computing environment 1300 which can implement one or more embodiments described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), and can include one or more external storage devices 1316 (e.g., a magnetic floppy disk drive (FDD) 1316, a memory stick or flash drive reader, a memory card reader, etc.). While the internal HDD 1314 is illustrated as located within the computer 1302, the internal HDD 1314 can also be configured for external use in a suitable chassis (not shown). Additionally, while not shown in computing environment 1300, a solid-state drive (SSD) could be used in addition to, or in place of, an HDD 1314.

Other internal or external storage can include at least one other storage device 1320 with storage media 1322 (e.g., a solid-state storage device, a nonvolatile memory device, and/or an optical disk drive that can read or write from removable media such as a CD-ROM disc, a DVD, a BD, etc.). The external storage 1316 can be facilitated by a network virtual machine. The HDD 1314, external storage device 1316 and storage device (e.g., drive) 1320 can be connected to the system bus 1308 by an HDD interface 1324, an external storage interface 1326 and a drive interface 1328, respectively.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera, a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can also be connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer 1350. The remote computer 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. The network connections shown are example and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a defined structure as with a conventional network or simply an ad hoc communication between at least two devices.

### CONCLUSION

The above description of illustrated embodiments of the one or more embodiments described herein, comprising what is described in the Abstract, is not intended to be exhaustive or to limit the described embodiments to the precise forms described. While one or more specific embodiments and examples are described herein for illustrative purposes, various modifications are possible that are considered within the scope of such embodiments and examples, as those skilled in the relevant art can recognize.

In this regard, while the described subject matter has been described in connection with various embodiments and corresponding figures, where applicable, other similar embodiments can be used or modifications and additions can be made to the described embodiments for performing the same, similar, alternative, or substitute function of the described subject matter without deviating therefrom. Therefore, the described subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures to optimize space usage or enhance performance of user equipment. A processor can also be implemented as a combination of computing processing units.

As used in this application, the terms “component,” “system,” “platform,” “layer,” “selector,” “interface,” and the like are intended to refer to a computer-related entity or an entity related to an operational apparatus with one or more functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of these instances.

While the embodiments are susceptible to various modifications and alternative constructions, certain illustrated implementations thereof are shown in the drawings and have been described above in detail. However, there is no intention to limit the various embodiments to the one or more specific forms described, but on the contrary, the intention is to cover all modifications, alternative constructions, and equivalents falling within the spirit and scope.

In addition to the various implementations described herein, other similar implementations can be used, or modifications and additions can be made to the described implementation for performing the same or equivalent function of the corresponding implementation without deviating therefrom. Still further, multiple processing chips or multiple devices can share the performance of one or more functions described herein, and similarly, storage can be implemented across different devices. Accordingly, the various embodiments are not to be limited to any single implementation, but rather are to be construed in breadth, spirit, and scope in accordance with the appended claims.

What is claimed is:

1. A system, comprising:
at least one processor; and
at least one memory that stores executable instructions that, when executed by the at least one processor, facilitates performance of operations, comprising:
based on sensed signals corresponding to a conversation, wherein the sensed signals at least partially correspond to voice soundwaves comprised in the conversation, recording the sensed signals as signal data;
analyzing the signal data based on classification data representative of at least one specification determined to be applicable to the conversation; and
based on the analyzing, mapping the signal data to an origination source representative of an origin of the sensed signals.

2. The system of claim 1, wherein the origination source is a first origination source, and wherein the operations further comprise:
identifying a pair of locations, associated with a time period applicable to the conversation, relative to one another, wherein the pair of locations correspond to the first origination source and a second origination source.

3. The system of claim 1, wherein the operations further comprise:
determining that the voice soundwaves comprise a previously unidentified voiceprint for which a corresponding voiceprint has not previously been stored in the classification data.

4. The system of claim 1, wherein the operations further comprise:
determining that the sensed signals involved in the conversation are from multiple distinct environments, and
wherein the recording of the sensed signals as the signal data comprises recording the sensed signals with metadata representing that the sensed signals are from the multiple distinct environments involved in the conversation.

5. The system of claim 1, wherein the operations further comprise:
analyzing the signal data, resulting in a determination that the sensed signals are from multiple recording devices that recorded the conversation.

6. The system of claim 1, wherein the operations further comprise:
determining, from the classification data, different voiceprints matching different origination sources, comprising the origination source, during the recording of the signal data.

7. The system of claim 1, wherein the operations further comprise:
in response to sensing a signal via an external sensor of a computing device in a dormant state, starting the recording of the signal data.

8. The system of claim 1, wherein the mapping comprises:
in response to analyzing the signal data, and based on the classification data, associating previously identified voiceprint data, representative of at least one voiceprint previously stored in the classification data, with voiceprint data determined from the analyzing of the signal data, and
tagging the signal data to correspond to the voiceprint previously stored in the classification data.

9. A method, comprising:
identifying, by a system comprising at least one processor, recorded signal data corresponding to voice soundwaves of a conversation;
assigning, by the system, respective origination sources corresponding to the voice soundwaves; and
generating, by the system, environmental map data comprising location data representative of respective locations of the respective origination sources relative to one another.

10. The method of claim 9, wherein the environmental map data further comprises environment data representative at least a pair of environments involved in the conversation,
wherein a first environment of the pair of environments comprises a first device that is connected, via a network, to a second device,
wherein a second environment of the pair of environments comprises the second device that recorded the recorded signal data, and
wherein the first environment is distinct from the second environment.

11. The method of claim 9, further comprising:
obtaining, by the system, classification data defining specifications corresponding to the conversation, the specifications comprising participant data representative of participants in the conversation; and
assigning, by the system, the respective origination sources based on the classification data.

12. The method of claim 9, further comprising:
based on the recorded signal data, generating, by the system, graph data representative of a graph comprising nodes corresponding to the respective origination sources and edges corresponding to the respective locations of the respective origination sources relative to one another.

13. The method of claim 9, further comprising:
receiving, by the system, query data comprising a query requesting an origination source, of the respective origination sources, corresponding to a specified time period corresponding to occurrence of the conversation; and
based on the assigning of the respective origination sources, generating, by the system, a response to the query.

14. The method of claim 13, wherein the generating of the response to the query comprises generating the response based on assignment data from a previous assignment of one or more origination sources corresponding to a prior conversation from a time prior to the conversation.

15. A method, comprising:
detecting, by a computing device comprising at least one processor, voice soundwaves of a conversation, using a sensor at an external surface of the computing device;
recording, by the computing device, signal data based on the voice soundwaves, using a microphone at the external surface or another external surface of the computing device; and
in response to the recording, generating, by the computing device, a notification that the recording has begun or is in progress.

16. The method of claim 15, wherein the generating of the notification comprises activating a light at the computing device.

17. The method of claim 15, wherein the detecting and the recording are performed while the computing device is in a dormant state.

18. The method of claim 17, wherein the dormant state of the computing device corresponds to a deactivated state or a sleep state of the computing device.

19. The method of claim 15, further comprising:
in response to manual contact of the sensor or another sensor at the computing device while the computing device is in a dormant state, triggering, by the computing device, starting of the recording.

20. The method of claim 15, further comprising:
in response to the sensing the voice soundwaves corresponding to at least one of a known voiceprint or a known timestamp, initiating, by the computing device, the recording, wherein at least one of the known voiceprint or the known timestamp correspond to classification data that defines specifications corresponding to the conversation.
